(19) United States
(12) Patent Application Publication
(10) Pub. No.: US 2008/0192630 A1
(43) Pub. Date: Aug. 14, 2008

(54) Control Method for Managing the Transmission Capacity of at Least One Relay Station of a Transmission System, and Corresponding Control Unit

(76) Inventors: Andreas Klimmek, Immenstaad (DE); Volker Jarsch, Stetten (DE); Karl Classen, Fronreute (DE)

Correspondence Address: KENYON & KENYON LLP, ONE BROADWAY, NEW YORK, NY, 10004, US

(21) Appl. No.: 10/530,742

(22) PCT Filed: Oct. 8, 2003
(86) PCT No.: PCT/EP2003/011135

§ 371 Date: Jan. 11, 2008

(30) Foreign Application Priority Data
Oct. 9, 2002 (DE) 102 47 028.6

(51) Int. Cl. H04J 3/16

(52) U.S. Cl. 370/230.1

(57) ABSTRACT

A control method for managing the transmission capacity of at least one relay station of a transmission system, a respective control unit, an appropriately adapted transmitting station, receiving station and relay station. The control method includes coordinating the transmission of the traffic to be transmitted with consideration of traffic already coordinated before within a specified time window and frequency range allowed for the transmission of the traffic to be transmitted, in which the traffic to be coordinated is composed of traffic contributions whose traffic volume is defined by the durations of the traffic contribution and the required bandwidth of the traffic contribution, and in which the coordinating is performed so that within the area of a frequency-time diagram defined by the allowed specified time window and the allowed frequency range the area of the traffic contributions is maximized.

### FIELD OF THE INVENTION

The present invention relates to a control method for managing the transmission capacity of at least one relay station of a transmission system, as well as a corresponding control unit.

### BACKGROUND INFORMATION

The exemplary embodiment and/or exemplary method of the present invention is not restricted to a particular transmission system, but it is described in more detail by way of the example of a satellite transmission system.

In such case a satellite is used as relay station of the transmission system. However, also earth-bound relay stations can be used as relay stations (for instance relay stations in radio link systems). Furthermore the exemplary embodiment and/or exemplary method of the present invention is not restricted to a particular transmission medium. Rather a wireless transmission, for instance via radio can be used, but also wire-bound transmission paths can be appropriately controlled. In general, any type of transmission can be controlled in a transmission system according to the exemplary embodiment and/or exemplary method of the present invention, for instance also in infrared transmission or transmission in the field of visible light wavelengths.

In the event of a transmission system using a satellite as relay station, a special case of application is the supply of video contributions (for instance interviews, reporting) to broadcasting corporations via satellite. This relates to the transmission of the contributions from a transmitting station (for instance a transmission car on the spot) via satellite as relay station to a TV station as receiving station. Consequently the transmission from the TV station to the home receiver is not concerned.

Video contributions of this kind representing the traffic or data traffic in the transmission system are mostly encoded in the MPEG format (MPEG=moving pictures expert group). This encoding enables the video signals to be transmitted at a data rate which is considerably reduced vis-à-vis the original video signal. In typical TV applications encodings are selected such that e.g. a data rate of 4 Mbps (megabit per second) or 6, 8, 16 or 24 Mbps is required for the actual transmission from the transmitting station via the satellite as relay station. A lower data rate of, for instance, 4 Mbps is used for lower requirements to the image quality (e.g. in interviews) and 24 Mbps for high requirements (e.g. sports transmissions). Within the MPEG standards there are in turn “subgroups” referred to as MPEG-1, MPEG-2 etc.

Before such an MPEG data flow is sent as traffic to be transmitted in the transmission system from the transmitting station to the satellite as relay station it must be processed, i.e. encoded, so that for instance a safe transmission is obtained. This is done in accordance with the DVB standard (digital video broadcast). Before the data encoded in this way can be transmitted, a transmission path must be established via the satellite. Such a transmission path is also referred to as link. Such a link is established by switching at the transmitting side the modulator and at the receiving side the demodulator to the frequency bandwidth and encoding corresponding to each other. The respective frequency bandwidth must have been reserved on the satellite before. Thus a cutout from the entire satellite capacity is made available to the respective user. Such a cutout is also referred to as slot.

At present different links are switched mostly manually, wherein it is observed that there occur no conflicts when using the satellite capacity. Two stations must not simultaneously transmit in the same slot.

An available system of Nétia company in France supports users and/or a network operator in making an interactive time planning of the occupation of satellite capacity via a bar-graph shaped user interface. Different users can book their transmission desires via a screen and these bookings are stored in a database. The user and/or the network operator can see which slots are free at the moment and at which times they are occupied. The system furthermore has a time control which switches the links between the different stations at the times stored in the database in such a way that no conflicts occur. To this end, it sends instructions to the transmitting and receiving stations and adjusts them for instance to the frequency and bandwidth of the link and switches off the link again upon expiry of the time provided.

This system is only adapted to DVB and/or MPEG transmissions, however, wherein a respective contribution is transmitted as continuous contribution.

For supplying video contributions to broadcasting corporations via satellite as a relay station satellite capacity is reserved in advance, as is evident from the foregoing. This reservation usually also covers periods of time in which nothing is transmitted. Consequently, although for the reserved satellite capacity costs are accrued, it is not used to a great extent. Furthermore it cannot be used by other users of the system, either, because it is reserved.

Moreover transmission peaks also occur due to the fact that contributions are transmitted at predetermined times, although they are not time-critical and could also be transmitted earlier or later within a predetermined time window. Because of such reservations furthermore other users are prevented from sending their own contributions at these times (or in these periods). A respective slot is frequently allocated in the long run, irrespective of whether or not it is used.

### SUMMARY OF THE INVENTION

The exemplary embodiment and/or exemplary method of the present invention generally relates to a control method for managing the transmission capacity of at least one relay station of a transmission system, the transmission system moreover comprising at least one transmitting station, at least one receiving station and a control unit controlling the at least one transmitting station, the at least one relay station and the at least one receiving station.

Consequently, it is an object of the exemplary embodiment and/or exemplary method of the present invention to efficiently exploit a slot and likewise keep the number of reserved/allocated slots as small as possible.

In accordance with the exemplary embodiment and/or exemplary method of the present invention, this object may be achieved, for instance, by a control method for managing the transmission capacity of at least one relay station of a transmission system, wherein the transmission system (FIG. 3) further comprises at least two transmitting stations (FIG. 4), at least one receiving station and a control unit (CTRL) coordinating the at least one transmitting station, the at least one relay station and the at least one receiving station, a respective transmitting station (FIG. 4) being designed so as to provide at least one type of traffic (IP) for transmission, a respective receiving station being designed so as to receive this at least one type of traffic and a respective relay station being designed so as to route this at least one type of traffic from the transmitting station to the receiving station, and the control unit coordinating the same being designed so as to perform the following steps of: detecting (S51, S21) the traffic to be transmitted by the at least two transmitting stations and coordinating (S53; FIG. 7) the transmission of the traffic to be transmitted with consideration of traffic coordinated already before within a specified time window and frequency range allowed for the transmission of the traffic to be transmitted, wherein the traffic to be coordinated is composed of traffic contributions whose traffic volume is defined by the duration of the traffic contribution and the required bandwidth of the traffic contribution, and wherein coordinating is carried out such that, within the area of a frequency-time diagram defined by the allowed specified time window and the allowed frequency range, the area of the traffic contributions is maximized.

According to the exemplary embodiment and/or exemplary method of the present invention, furthermore this object is achieved, for instance, by a control unit for managing the transmission capacity of at least one relay station of a transmission system, wherein the transmission system moreover consists of at least two transmitting stations and at least one receiving station, wherein a respective transmitting station is designed so as to provide at least one type of traffic for transmission and a respective relay station is designed so as to route this at least one type of traffic from the transmitting station to the receiving station, and wherein the control unit comprises: a detecting arrangement (S51, S21) for detecting the traffic to be transmitted, a coordinating arrangement for coordinating (S53; FIG. 7) the transmission of the traffic to be transmitted with consideration of traffic coordinated already before within a specified time window and frequency range allowed for the transmission of the traffic to be transmitted, wherein the traffic to be coordinated is composed of traffic contributions whose traffic volume is defined by the duration of the traffic contribution and the required bandwidth of the traffic contribution, and wherein coordinating is carried out such that, within the area of a frequency-time diagram defined by the allowed specified time window and the allowed frequency range, the area of the traffic contributions is maximized; and control arrangement which, in response to an output of the coordinating arrangement, control the coordinated transmission of the traffic from the respective at least one transmitting station via the at least one relay station to the respective at least one receiving station.

Advantageous further developments of the exemplary embodiment and/or exemplary method of the present invention are described herein.

“Coordinating” implies in this context that the control unit and the method, respectively, ensure that only one transmitting station at a time is transmitting on a slot.

By virtue of the exemplary embodiment and/or exemplary method of the present invention a slot is consequently efficiently exploited, the number of slots required for one user can be kept as small as possible and, as a consequence, the user can transmit his video contributions inexpensively to the TV station. Furthermore transmission capacity is not blocked for other users by time-uncritical video contributions which—although they are uncritical as to time—have already reserved a transmission capacity within a predetermined time window.

Especially the efficiency of the use of the relay station is improved by combining transmission techniques for a respective allocated type of traffic (for instance TDMA and IP-DVB) in combination with the control method. The control method discriminates between store and forward transmissions and real-time transmissions and transmits them depending on required and available satellite capacity. Another criterion of distinction for types of traffic is the data volume of the contributions resulting from the data rate and the duration of a contribution. The use of plural transmitting and/or receiving stations according to the exemplary embodiment and/or exemplary method of the present invention in a network moreover enables the TV organizations or studios to exchange comprehensive contributions such as films, interviews and reporting. Thus the system according to the exemplary embodiment and/or exemplary method of the present invention permits new services and applications, entails a straightening out of the traffic and a better distribution of the satellite use and accompanying cost savings and/or gain in profit/turnover by an extended use of available resources.

### BRIEF DESCRIPTION OF THE DRAWINGS

FIG. 1 shows a schematic representation of the allocation of types of traffic to transmission modes.

FIG. 2 shows a flow chart illustrating details of a mode selection.

FIG. 3 shows a block diagram of a transmission system in which the control method according to an exemplary method of the present invention is applied.

FIG. 4 shows a block diagram of a transmitting and/or receiving station according to the exemplary embodiment and/or exemplary method of the present invention.

FIG. 5 shows a flow chart illustrating the steps of coordinating the transmission.

FIG. 6 illustrates two transmissions in a frequency-time diagram.

FIG. 7 illustrates details of a method of coordination according to the exemplary method of the present invention.

FIG. 8 illustrates an optional bandwidth reservation.

FIG. 9 illustrates an optional resource administration.

### DETAILED DESCRIPTION

Hereinafter the exemplary embodiment and/or exemplary method of the present invention is described in detail with reference to the drawings.

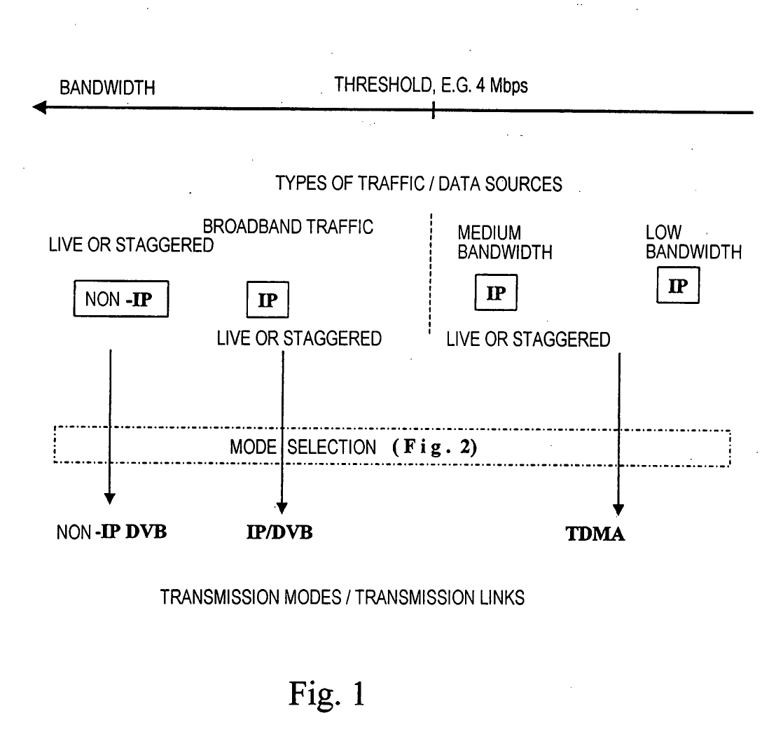

FIG. 1 shows a schematic representation of allocating types of traffic to transmission modes and/or links. As illustrated in FIG. 1, for instance video contributions can be divided into different types of traffic. These types of traffic can be based, for instance, on different data sources or different encoding methods. Types of traffic can be distinguished on the one hand by way of their data rate. In FIG. 1 an arrow from the right to the left indicates the direction of an increasing data rate. A threshold which can be freely defined marks a data rate above which one speaks of broadband traffic and below which one speaks of medium bandwidth traffic to low bandwidth traffic. Another threshold (not shown) serves for discriminating between low bandwidth traffic and medium bandwidth traffic. Within broadband types of traffic according to FIG. 1 it is discriminated between traffic not based on the Internet protocol (hereinafter referred to as non-IP traffic) such as, e.g., MPEG traffic which is not based on the Internet protocol IP and traffic based on the Internet protocol IP. For both types of traffic it can further be discriminated between live or real-time traffic and traffic recorded in advance (store and forward traffic) which is sent staggered in time after recording. This discrimination between live transmission and store and forward transmissions is also applicable to medium bandwidth traffic based on IP. Low bandwidth traffic arrangement, for instance, voice transmissions based on the Internet protocol which are usually transmitted in real time and are referred to as VoIP or “voice over IP”.

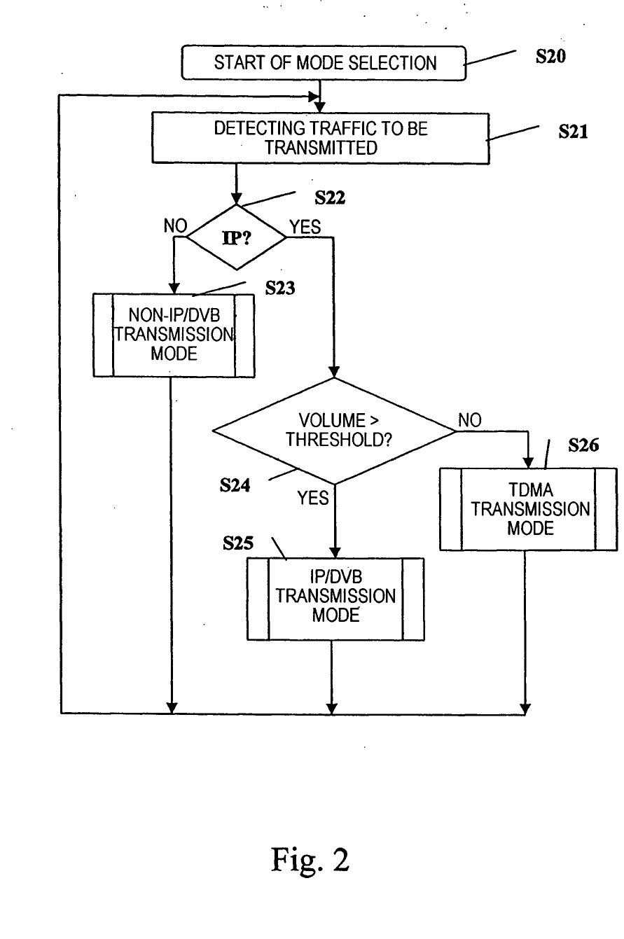

Depending on the type of traffic a mode selection described in more detail in FIG. 2 is performed which results in the selection of a transmission mode and a transmission path, respectively, for the respective traffic. In this context it can be selected between a DVB transmission, an IP/DVB transmission or a TDMA transmission (TDMA=time division multiple access or time-division multiplex, resp.).

FIG. 2 illustrates a flow chart which shows details of a mode selection. The mode selection starts, according to FIG. 2, in a step S20. It has to be observed that each transmitting station performs such a mode selection for the contributions to be transmitted by it and/or for the traffic to be transmitted by it (“traffic” includes all data to be transmitted, i.e. payload data and control data). (However, this mode selection may be shifted toward the control unit.) It has furthermore to be observed that a transmitting station can equally be a transmitting-receiving station, wherein in connection with the exemplary embodiment and/or exemplary method of the present invention the transmitting station part is considered separately from the receiving station part for such a transmitting-receiving station, however. In step S21 the traffic to be transmitted is detected. The traffic to be transmitted can arrive in real time from the data source, via an interconnected encoder, where appropriate, at the transmitting station (e.g. MPEG and/or non-IP) or can be stored already on a storage medium allocated to the transmitting station (e.g. IP). At step S22 it is discriminated whether the traffic is provided, for instance, in the IP format. The verification of whether the traffic is provided, for instance, in the IP format can be made by way of the data format and can be restricted, for instance, to checking the identification. It can also be checked, however, by the interface via which the traffic is input whether or not it is IP traffic. If NO, the non-IP/DVB transmission mode is selected according to step S23. Since the non-IP/DVB and/or DVB transmission mode per se was mentioned already in connection with the aforementioned prior art and therefore is provided as should be understood by a person skilled in the art, hereinafter a detailed description of the DVB transmission mode is dispensed with. If YES at step S22, in a subsequent step S24 it is established whether or not the traffic volume of the traffic provided in the IP format is larger than a predetermined threshold. The traffic volume can be determined by the data rate of the traffic and the duration of the traffic. If step S24 results in the fact that the volume is smaller than or equal to the threshold (NO), the operation progresses to step S26 according to which TDMA (time-division multiplex) is selected as transmission mode. If the volume at step S24 is determined to be larger than the threshold (YES), according to step S25 the transmission mode IP/DVB is selected. After step S23, S25 and S26 the operation returns to step S21 again and the operation is restarted. It has to be observed that the designation IP/DVB selected in FIGS. 1 and 2 denotes a type of traffic based on IP traffic and modified into DVB format.

As regards the determination of the volume of the traffic in step S24, it has to be observed that with so-called “staggered” traffic the traffic volume is determined already by the file size if the file is provided already when booking for transmission (e.g. on a storage medium) or can be indicated by the operator. In real-time traffic the volume is operator-specified or it is fixed by way of the interface data rate of the interface used or other configuration parameters.

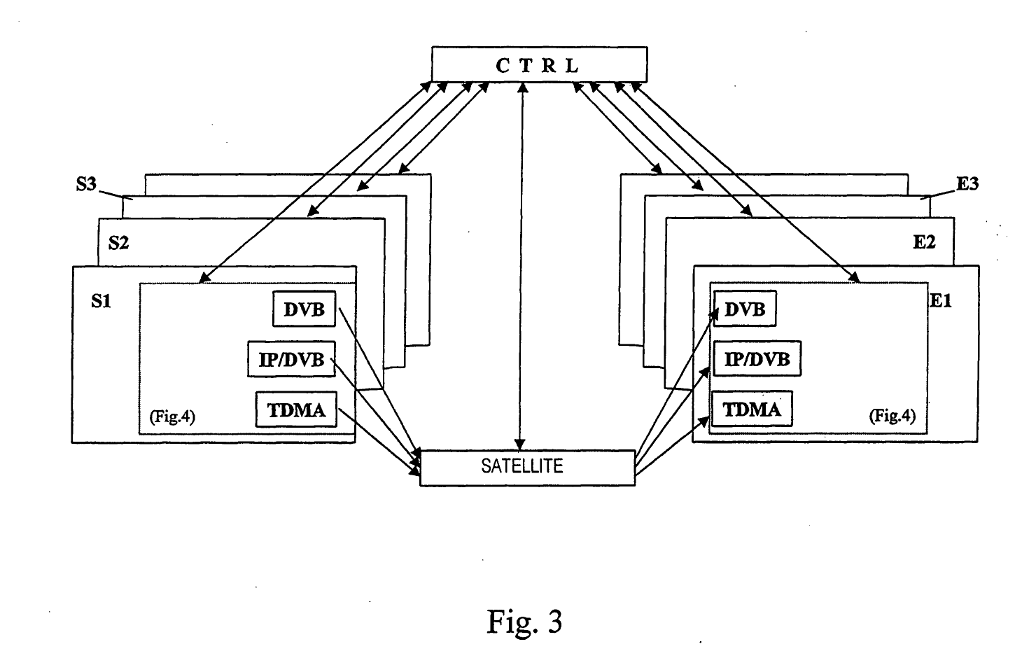

FIG. 3 shows a block diagram of a transmission system in which the control method according to the exemplary embodiment and/or exemplary method of the present invention is applied. The transmission system consists, as shown, of at least one transmitting station S1, S2, S3, at least one receiving station E1, E2, E3 and a relay station referred to as satellite in FIG. 3. The transmitting stations, the relay station and the receiving stations are controlled by a control unit CTRL. The latter manages the transmission capacity of the relay station and controls the transmitting, routing and receiving times and modes of the transmitting stations, relay station and receiving stations. Each transmitting station may at the same time also have characteristics of a receiving station and then form a transmitting-receiving station. Equally the transmission system can have plural relay stations whose transmission capacity is managed by the control unit. For reasons of a simple representation, however, only one relay station is shown. The transmitting stations S1, S2, S3 are mobile transmitting stations, for instance, from which the contributions are sent to one or more receiving stations E1, E2, E3.

The receiving stations can be TV stations and/or broadcasting corporations, for example, from which the received traffic is further transmitted to the “final consumer” and his/her TV set.

As it is indicated in FIG. 3 in the form of a block diagram, a respective transmitting station is designed to provide at least one or more different types of traffic for transmission. These types of traffic are denoted with DVB (non-IP), IP/DVB and TDMA in FIG. 3. Accordingly, the relay station (the satellite) is designed to route one or more of these different types of traffic from the transmitting station to the receiving station. The receiving station is equally designed to receive these different types of traffic, IP/DVB, (non-IP) DVB and TDMA. The coordinated and synchronous sending, routing and receiving are controlled by the control unit CTRL. The control unit communicates with the transmitting station or stations, the receiving station or stations and the relay station (or the relay stations in the case of plural relay stations). For this purpose, the transmitting stations include communication arrangement for communicating information designating detected and discriminated traffic to be transmitted to the control unit. Furthermore the transmitting stations are equipped with the receiving arrangement for receiving control instructions sent by the control unit for a coordinated transmission of the traffic to be transmitted in response to the control instructions. Accordingly, the control unit includes the detecting arrangement for detecting the traffic to be transmitted. These detect, for instance, the information designating the traffic to be transmitted which was communicated by the transmitting station. Moreover the control unit includes discriminating arrangement for discriminating the traffic types of the traffic to be transmitted, wherein, in response to the discriminated type of traffic, the transmission mode ((non-IP) DVB, IP/DVB or TDMA) is determined for the respective traffic by the determining arrangement. The control unit moreover includes the coordinating arrangement (for instance in the form of a data base and a coordinating program) for coordinating the transmission of the traffic to be transmitted with consideration of traffic already coordinated before and within a time window and a frequency range, where appropriate, specified for the transmission of the traffic to be transmitted. The specified time window is specified by the user of the transmitting station, for instance via a man-machine interface of the transmitting station such as, for instance, a personal computer PC connected thereto or the like. The control unit further includes control arrangement which, in response to an output of the coordinating arrangement, control the coordinated transmission of the traffic in the fixed type of traffic from the at least one transmitting station via the at least one relay station to the at least one receiving station. For this purpose, the control arrangement output control signals to the transmitting station, the receiving station and the relay station. Information and instructions, respectively, transmitted between the transmitting station, the relay station and the receiving station, on the one hand, and the control unit, on the other hand, are indicated by two-sided arrows in FIG. 3. In this context, however, there need not necessarily be a direct connection between the control unit and the relay station and/or the receiving station. Rather, the control unit can forward control signals to the receiving station E1, for instance, to the transmitting station S2 and from there to E1 via the TDMA transmission path. Then the TDMA transmission from S1 takes place advanced in time to IP or non-IP payload transmission so that the transmitting and receiving stations are coordinated with each other.

Likewise control signals can be forwarded to the relay station in this way.

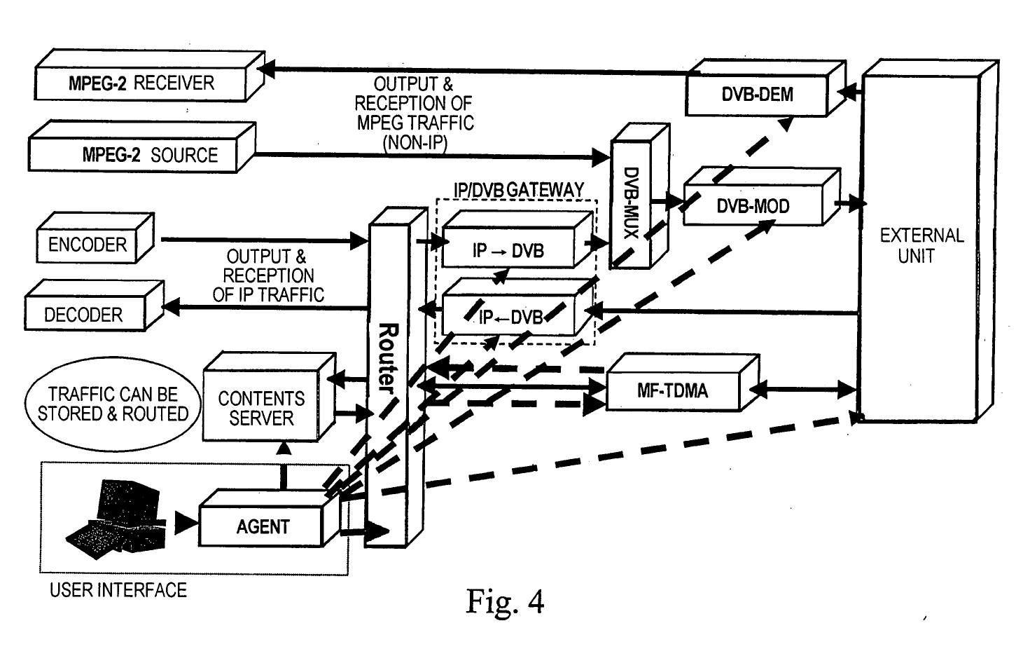

FIG. 4 shows a block diagram of a transmitting and/or receiving station according to the exemplary embodiment and/or exemplary method of the present invention. The structure of a transmitting/receiving station according to FIG. 4 illustrates a case in which the exemplary embodiment and/or exemplary method of the present invention is used in combination with the available system mentioned in the beginning.

Therefore, first of all, the part of the available system in the station shown in FIG. 4 is described. As shown in FIG. 4, the transmitting/receiving station contains, e.g., a MPEG-2 source as example of a source for non-IP based traffic which in its function as the origin of data traffic in the transmission system outputs an appropriately encoded data flow. The source outputs the traffic via a DVB modulator to an external unit. According to the representation in FIG. 4, a DBV multiplexer DVB MUX is switched between the source and the DVB modulator. It is required only when the available system is not used independently, however. The external unit comprises, for instance, an antenna and allocated amplifiers and outputs the signals appropriately processed by the same to the relay station. Details of the external unit depend on the chosen transmission medium, however (radio, infrared, light, cable or the like).

At the receiving side the data flow is inverted. That is to say, traffic received from the relay station (the satellite) is processed in the external unit, is supplied to a DVB demodulator and is transmitted from the latter to an (e.g. MPEG-2) and/or non-IP based receiver. The traffic can take place in real time. However, it can have been stored before both at the transmitting side and at the receiving side and can be sent at predetermined points in time. In this case a data storage unit (not shown) is provided in the station. This data traffic (payload) as a type of traffic is a type of traffic which is not based on the Internet protocol.

In addition or as an alternative to the previously described components of a transmitting/receiving station, the exemplary embodiment and/or exemplary method of the present invention suggests a transmitting/receiving station in which at least one further type of traffic can be transmitted. According to the representation in FIG. 4, a traffic and/or data flow based on the Internet protocol is used as an example. At the transmitting side the transmission takes place as follows.

A data flow received from a not represented data source is supplied to an encoder and is output by the latter to a routing element ROUTER as a data flow and/or traffic based on the Internet protocol IP. Depending on the type of traffic, the routing element transmits the traffic in a fixed type of traffic. If, for instance, a broadband traffic based on the Internet protocol IP is concerned, the router routes the traffic via an IP/DVB gateway and the already mentioned subsequent DVB multiplexer via the DVB modulator to the external unit and from there to the relay station. The IP/DVB gateway converts IP-based traffic into DVB-compatible traffic. If, however, traffic of medium or low bandwidth is concerned, the router routes the traffic via a TDMA (time-division multiplex) transmission path to the external unit and from there to the relay station. The TDMA transmission path can work on different frequencies and therefore is also referred to as multi-frequency MF-TDMA arrangement. The traffic arriving at the router via the encoder is real-time traffic. However, likewise store and forward/time-uncritical traffic can be transmitted dependent on the bandwidth required for the same via the alternative transmission links (IP/DVB or MF-TDMA). Such traffic subject to time-uncritical transmission is stored in a content memory or contents server, respectively. The traffic is stored in the IP format as data flow and can be called in as required. The traffic from the encoder may be routed via the router to the contents server and to store it for later sending. Moreover the router can include a (not represented) interface to the Internet, to an Intranet or a private network so that traffic/payload can be routed along this path to and away from the contents server.

In the event of IP traffic, too, the course of traffic is inverted at the receiving side. That is to say, traffic received by the relay station arrives via the external unit optionally via the IP/DVB gateway, then a DVB->IP converter to the router and/or via the MF-TDMA transmission link to the router. From the router it is in turn either supplied directly to the decoder, possibly subsequently stored in a decoded form, or stored directly (non-decoded) on the contents server. It is noted that continuous lines according to FIG. 4 represent data traffic while lines represented as broken lines represent control signals.

The user in this context may enter instructions to the system control via a user interface represented as workstation computer or PC. For instance, the user can fix a desired time window for the transmission in this way. The system control does not only receive instructions from the user interface, but can also display error messages and/or feedbacks to the user on the user interface. Moreover, based on instructions received from the control unit, a unit referred to as agent controls (via a not represented interface to the same) the contents server, the router, the IP/DVP gateway, i.e. both the IP->DVB conversion at the transmitting side and the DVB->IP conversion at the receiving side, the DVB multiplexer, the DVB modulator and the DVB demodulator and finally both the MF-TDMA transmission path and the external unit.

From the not shown source likewise information concerning the type of traffic of the traffic output by the source (IP and/or non-IP) can be communicated to the user interface. This is performed via another interface not represented.

The entire traffic of data can be divided into payload constituting the actual content to be transmitted such as, e.g., the video contribution and into control data. The control data can be transmitted (by virtue of their low data volume and their real-time requirements) via the TDMA transmission link so as to appropriately control the relay station and/or the receiving station in order to be capable of routing and/or receiving the traffic sent from the transmitting station.

The detecting arrangement, the discriminating arrangement, the communicating arrangement and the receiving arrangement provided at the transmitting station are represented by the agent and/or the user interface. The receiving arrangement provided at the receiving station side for receiving control instructions sent by the control unit are equally represented by the agent and/or the user interface.

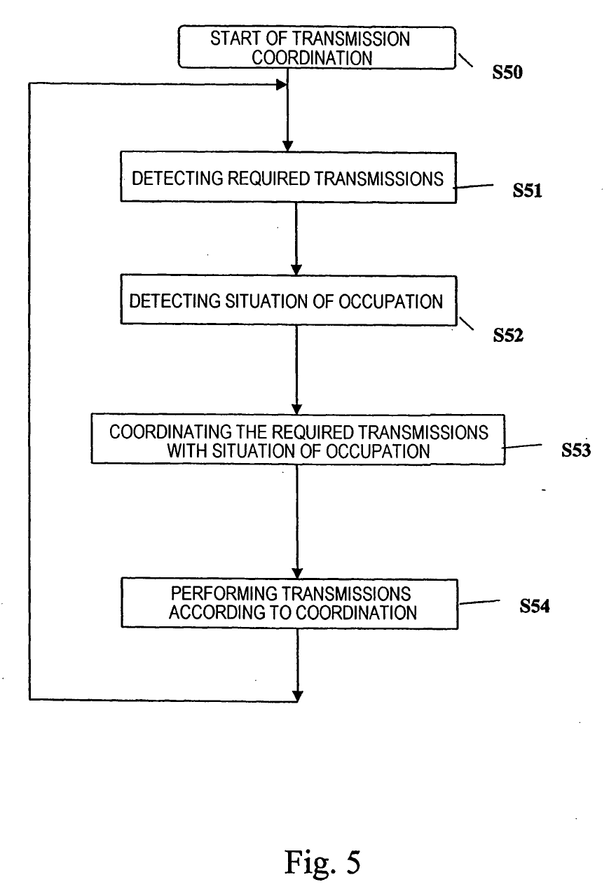

FIG. 5 shows a flow diagram illustrating the steps for coordinating the transmission. The coordination of transmission starts in step S50. At step S51 required transmissions are detected. To this effect, e.g., all transmitting stations communicate the transmissions required at the same, the required bandwidth for the transmission, the duration of transmission (wherein the volume of the transmission can be determined from bandwidth and duration) as well as the desired time window for the transmission, or else the user books via the transmitting station or the user interface thereof, resp., the transmission at the control unit, wherein the a.m. information can be communicated via the TDMA transmission link to the transmitting station. A time window denotes a desired period of time within which the transmission is to be carried out (i.e. at least is to start and possibly also end). Under certain circumstances, the time window is larger than the required transmission time. In the subsequent step S52 the situation of occupation is detected. For this purpose, the control unit determines all reservations currently provided for the relay station for transmissions from all transmitting stations having access to the same. The control unit is further informed about the situation of occupation of the receiving stations, wherein a situation of occupation of a receiving station indicates when a corresponding transmitting station transmits or will transmit to this receiving station. Then the control unit performs the coordination of the transmissions in step S53. As a result of the transmission coordination subsequently in step S54 the control unit controls the transmissions according to the coordination. After that the operation returns to step S51. It has to be observed that this operation does not run in closed cycles as indicated in FIG. 5 for reasons of a simplified representation, but that transmissions newly required each time are detected, coordinated with existing occupations, thus lead to new situations of occupation and transmissions are continuously carried out in an appropriately coordinated manner. Coordinating the transmission thus is performed with consideration of traffic coordinated already before and takes place within a time window specified for the transmission of the traffic to be transmitted. A time window itself is subdivided in turn into a plurality of time units. It is not decisive for the purposes of the exemplary embodiment and/or exemplary method of the present invention how long the shortest time unit is. For instance, a time window can be defined in multiples of hours or else only in multiples of minutes. Likewise a second may be a shortest common time unit for the definition of time windows.

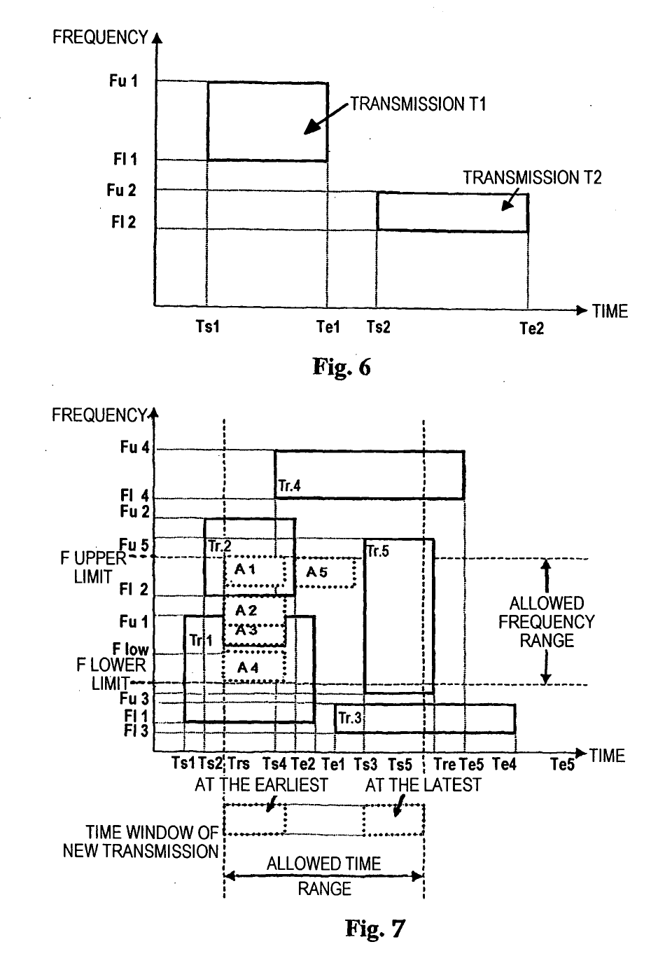

Hereinafter details of coordinating the requested transmissions with the situation of occupation according to step S53 will be illustrated with reference to the FIGS. 6 to 9.

Coordinating the requested transmissions is performed by way of a resource allocating algorithm. The following resources are allocated for a transmission in all networks of the system controlled according to the exemplary embodiment and/or exemplary method of the present invention:
Data sources as server directories for a store & forward transmission, or cameras for a live transmission (these are provided as an application in the network but are not considered to be part of the network),
optionally encoders and/or decoders or encryptors and decryptors (for encrypted transmission),
uplink sending equipment,
satellite bandwidth or terrestrial bandwidth,
downlink equipment (receivers),
data sinks such as e.g. a receiving server.

The data sources can either be used for the non-IP/DVB network (in FIG. 4 shown for instance by the “pure” DVB data path) or for the IP/DVB network (in FIG. 4 indicated by the IP/DVB gateway and pertinent components), the MF-TDMA network or the terrestrial network, because data based on the IP protocol can be routed by any of these networks.

Resources of the non-IP/DVB network are allocated by a central network administration system which exists already. Data are transmitted in the non-IP format such as, for instance, in a MPEG format.

Satellite bandwidth is allocated automatically as required and is internally allocated within the MF-TDMA system. Therefore no separate resource allocation for the MF-TDMA network is required.

The bandwidth of the terrestrial network which can be provided for the system controlled according to the exemplary embodiment and/or exemplary method of the present invention is managed by the control unit. The respective capacity is reserved for the control unit, because otherwise no guarantee concerning the transmission within a particular time would be feasible. As regards the time control and bandwidth control (bandwidth correlates with the frequency utilized), a transmission is defined by its start time and its end time, wherein for n transmissions in this case a transmission is described by the parameters Ts(n) for the start time and Te(n) for the end time. The frequency band is correspondingly denoted with the upper frequency limit Fu(n) and the lower frequency limit Fl(n). With this notation (n) denotes the number of the respective transmission.

FIG. 6 illustrates this allocation and definition by way of two transmissions T1 and T2 in a frequency-time range.

A collision exists between two transmissions if both transmissions overlap in the time range and in the frequency range. No collision exists if the two transmissions do not overlap in the time range or in the frequency range. In other words, a collision exists between two transmissions T1 and T2, if the following conditions are true:

Overlap in the time range:
(transmission 2 starts before end of transmission 1) and (transmission 1 starts before end of transmission 2).

In mathematical terms this corresponds to the following formula

(Ts2<Te1) and (Ts1<Te2)

Overlap in the frequency range:
(lowest frequency of transmission 1 is lower than upper frequency of transmission 2) and (lowest frequency of transmission 2 is lower than upper frequency of transmission 1).

In mathematical terms this can be expressed by the following formula

(fl1<fu2) and (fl2<fu1)

Summarized, a collision exists between two transmissions exactly if
(Ts2<Te1) and (Ts1<Te2) and (fl1<fu2) and (fl2<fu1).

Optionally a guard time is provided between an end of one transmission and a start of next transmission, wherein the guard time is internally added and/or deducted from the start and end times.

Internally receiving equipment and/or a receiver must be switched some time before the start of a transmission. This time will depend on the type of hardware.

In general a transmission can be booked when frequency and/or bandwidth are available (no conflict occurs in this respect), hardware is available (on the required frequency and/or bandwidth) and when data are available (for store and forward and/or time-uncritical routing after storage).

### Calculation of the Complete Booking

The algorithm presented hereinafter provides reasonable results but does not exclude any further improvements.

The following steps are performed when calculating a complete booking of all transmissions:
1. Transmissions defined or modified by a super user or network manager, respectively, by a manual intervention in a central network management system are checked,
2. continued and/or already running transmissions are checked,
3. live transmissions (for which there is no time window within which they could be shifted) are checked, and
4. store and forward transmissions (which are stored and to be routed within a time window which is greater than or equal to the duration of the transmission) are examined.

When calculating the booking or the sending times, resp., it is always checked whether a single new additional transmission can be added. The booking and/or booking schedule is complete when this has been done for all transmissions. In principle, the same basic algorithm can be performed at all steps, but differences regarding priorities exist between the respective steps.

### For 1. and 2.:

It is verified for each transmission with respect to each other transmission that no collision exists. This might not be required, because no collisions should exist here in theory.

### If No Collision Exists:

Storing the allocation of the transmission which results in booking the transmission.

### For 3.:

The transmission to be booked first is selected (transmission having the earliest start time). The upper frequency limit and the lower frequency limit of the available bandwidth and all upper frequency limits of transmissions existing during the planned time interval of the transmission are taken into account. Based on the available bandwidth for this type of transmission, data rate of the transmission and direction of search, the upper frequency limit is first selected. It is checked whether a collision is provided with any other transmission defined or booked before. If a collision exists, the search is carried out with the next upper frequency limit. It is checked whether specified transmitting and receiving equipment is available. If a collision exists, it is continued with the next upper frequency limit. If no collision exists, the allocation of the transmission is stored and the algorithm is repeated for the next transmission. If no upper frequency limit exists any more, a message is output to the operator that the transmission cannot be booked. If no transmission which has to be booked remains, it is continued with store and forward transmissions.

For 4., i.e. Store and Forward Transmissions within a Time Window:

In principle the same algorithm applies as for live transmissions, but:
this time as start times of the new transmission all ending times of transmissions within the allowed window of start times of the transmission can be checked, and
transmissions are selected on the basis of the size of files to fill “holes” with as big transmissions as possible. Short transmissions fit in small “holes”, long transmissions don't.

A detailed description of this case is given using the example according to FIG. 7.

FIG. 7 shows a frequency-time diagram in which transmissions Tr1 to Tr5 are considered to be fixedly booked, for instance because they have been defined by a super user, represent already running transmissions or represent live transmissions. A new transmission can be transmitted in an allowed time range (time window) which is defined by the earliest possible start time for transmission and a latest possible end time for transmissions. Furthermore the transmission may take place in an allowed frequency range (bandwidth range) which is defined by an upper frequency limit (F upper limit) and a lower frequency limit (F lower limit).

The algorithm starts with a defined start frequency (here upper limit) and the start of the allowed time range. The transmission to be newly booked is denoted with the letter A, wherein FIG. 7 illustrates booking attempts A1 to A5 illustrating the course of failed bookings (A1 to A4) up to a successful booking (A5).

Attempt 1 (A1) with Trs (start of time range) and F upper limit (upper limit of allowed frequency range): a conflict with transmission 2 exists, therefore it is continued with:
Attempt 2 (A2) with Trs, Fl2 (lower frequency of transmission 2): a conflict with transmission 1 exists, therefore it is continued with:
Attempt 3 (A3) with Trs, Fu1 (upper frequency of transmission 1): a conflict with transmission 1 exists, therefore it is continued with:
Attempt 4 (A4) with Trs, F low (F lower limit plus bandwidth of new transmission, lowest possible frequency at which the transmission can be inserted): a conflict with transmission 1 exists, therefore it is continued with:
Attempt 5 (A5) with Te2, F upper limit (upper limit of allowed frequency range): No conflict exists, therefore the new transmission A is booked within the time-frequency diagram at the location denoted with A5.

Optionally the checking of the upper frequency limits Fu(n) might be dropped. Afterwards also the verification of the availability of other resources such as transmitting and receiving equipment takes place. If all conditions are met, the transmission is booked, otherwise the search process continues.

It has to be observed that the start time of transmission 4 is not taken into account, because this transmission is completely outside the allowed frequency range for the transmission A to be newly booked (traffic contribution). Advantageously such checking, which results in the fact that the consideration of previously booked transmissions is excluded, can take place at the beginning of the algorithm.

It is likewise not required to take other frequencies (or times) into account, e.g. between Fl2 and Fu1, because the transmission is either feasible for Fl2 or for no other frequency between Fl2 and Fu1.

Likewise the algorithm packs transmissions in a better way, if only Fl2 is taken into account. In addition to the algorithm described, large files must have priority, because otherwise large holes would be filled with small transmissions in the time-frequency diagram, and the large “holes” thus cannot be used for large traffic contributions such as e.g. files, whereas large files cannot use small “holes” which would be sufficient for small transmissions. The time of the transmission can be calculated based on the size of the file and the bandwidth plus a safety margin. Optionally a mechanism may be implemented which checks whether a transmission has ended and terminates the transmission earlier if this is feasible (i.e. switches off transmitter and receiver and shows the booked capacity as free again). The booking algorithm likewise starts automatically when a transmission has been modified (extended or shortened) or deleted. As an option, the priority may be subdivided into several priority classes. In this case the same algorithm applies, but additional steps of higher or lower priority are introduced.

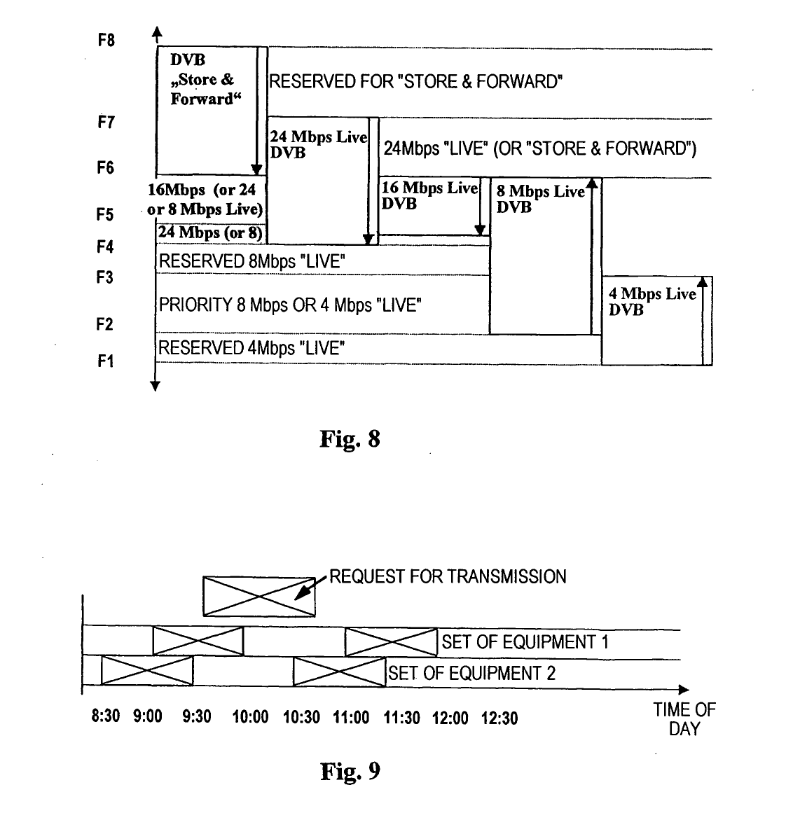

So far the algorithm has been described regarding one single frequency band and one single bandwidth pool, respectively. As an option, the total available bandwidth may be subdivided into different so-called bandwidth pools as represented in FIG. 8. A respective pool or bandwidth range, resp., may then be reserved for a respective type of traffic. This is described in detail hereinafter.

As regards the bandwidth ranges, for instance the following possibilities exist having the described functions: Carriers can be reserved for store and forward transmissions or for specific types of transmissions by setting the upper (or lower) frequency limit of all other types of transmissions to a lower (or higher) value.

The parameters “upper limit of the available bandwidth”, “lower limit of the available bandwidth”, “direction of search” (from upper to lower limit or vice versa) are definable based on a type of transmission and a data rate of the transmission. This feature permits, for instance, the reservation of a bandwidth range for one of more types of applications or specific data rates, minimization (or delimitation) of the “tetris problem” (described before with reference to FIG. 7) by concentrating transmissions having similar speeds in different bandwidth ranges, while these bandwidth ranges can be used in case the “home” bandwidth range is completely booked or occupied, as well as a flexible modification of bandwidth ranges, if, e.g., MF-TDMA carriers are added or removed in specific bandwidth ranges.

An example of bandwidth pools for particular applications in shown in FIG. 8. The entire bandwidth is provided between frequencies F1 and F8 and subdivided into the individual frequency ranges F1 to F2, F2 to F3, F3 to F4, F4 to F5, F5 to F6, F6 to F7 and F7 to F8. The frequencies can be ascending from F1 to F8 but they can also be ascending from F8 to F1. As shown in FIG. 8, e.g. for a non-IP based (for instance DVB based) “store and forward” the range between F7 and F8 has been reserved, wherein likewise the range between F6 and F7 is used, however the range between F7 and F8 may be used, if capacity is available there. The start value for the search (as basically described with reference to FIG. 7) therefore is F8, the end value is F7 and the direction of search is from F8 to F7. For live transmissions and real-time transmissions of 8 megabits per second the range between F3 and F4 is reserved, but it is also attempted to use the range between F2 and F3 first, attempts to use the range between F4 and, respectively, F5 and F6 are only made, however, if there are no other alternatives, because this might cause a “tetris problem” for transmissions of 24 megabits per second or 16 megabits per second.

Active transmissions are listed in a table of the transmissions with frequencies and bandwidths (and the active resources). Currently not yet active allocating locations do not have a fixed allocation of frequencies, bandwidth and resources but get that at the time when the transmission becomes active. As an exception of this rule, virtual bandwidth allocations, which were made in order to reserve bandwidths which are used by MF-TDMA or by non-IP/DVB traffic, have fixed frequencies.

Frequency bands can be released for MF-TDMA by setting the upper (or lower) limit of all other frequency bands to a different value. In this case verification is made to the effect whether all transmissions can be re-booked and whether a transmission is active which would otherwise have to be aborted and repeated after a request by the operator.

Modifications are allowed for normal users only if there is no conflict with existing bookings. In the case of conflicts with existing bookings, these can be made by the network operator.

In addition to verifications of available bandwidth the following verifications must be made:

Determination of a feasible modulation as a function of the list of receiving locations, determination of the bandwidth as a consequence of modulation, determination of the availability of the bandwidth, search for bandwidth,
determination of the availability of transmitting equipment at a predetermined time, determination of the availability of receiving equipment at a predetermined time, if the equipment is not available, the next free slot of bandwidth is searched, if no bandwidth slot and no equipment is available, the transmission cannot be reserved.

A resource can only be allocated, if the allocating user has access to the resource group to which the resource belongs.

In principle, this means that if one of these conditions fails or does not exist the transmission cannot be set up. However, a mechanism for a “soft” decision-making will be required. For instance a transmission is made with 8-PSK if 16 QAM is not available at all the locations in the network, and in some cases transmissions will probably be feasible if no receiving equipment is available at few unimportant locations.

The operator gets information during booking whether all non-IP receivers (for instance DVB receivers) or only a part of them are available. He then decides whether he books the transmission although not all DVB receivers are available.

For a successful transmission also the file to be transmitted (the traffic contribution) must be available.

Conflicts with booking exist if e.g. a receiver is damaged and requires the re-transmission of many packets, which in turn prolongs the transmission very much. A detection of the end of transmission would be required, which, however, causes delays of the start of subsequent transmissions.

The system also uses resource pools, wherein a resource represents either transmitting equipment or receiving equipment, in order to avoid deadlocks and/or blockings at bookings. At the time of a booking only the information whether or not a resource is available is required, but not already the allocation of the resource. Allocation of a specific device takes place only at the start of transmission.

FIG. 9 shows an example of a situation without resource pools where no reservation or booking, resp., is feasible:

Receiving equipment 1 is reserved from 9:00 to 10:00 and between 11:00 and 12:00,
receiving equipment 2 is reserved from 08:30 to 09:30 and between 10:30 and 11:30.

A new reservation concerning the request for transmission between 09:45 and 10:45 shown at the upper edge of FIG. 9 is not feasible with fixed allocation of the equipment, because both sets are in operation at some time during the requested transmission; it would be feasible with resource pools, however.

With resource pools the transmission between 09:45 and 11:45 can be made by the receiving equipment 2 and the transmission between 10:30 and 12:00 can be booked for the receiving equipment 1. This is feasible if identical equipment out of a resource pool can be booked. (I.e. the two receivers can receive at the same frequencies etc.).

Without resource pool a manual intervention would be required to permit the use of equipment 1 instead of equipment 2 and vice versa. The control unit knows how many sets of equipment are available (at a transmitting and/or receiving station) and allocates the specific set of equipment immediately before the start of transmission but not at the time of booking.

Precondition for resource pools is the use of identical equipment in each pool. A pool can also consist of only one set of equipment. The system control counts the number of free sets of equipment in each pool and does not discriminate between the sets of equipment to obtain a limited complexity. Such resource pools are implemented both for receiving equipment and for transmitting equipment.

The following basic functions are necessary in order to start a new transmission with a simple algorithm:
a next transmission is selected at a time which is entered by the operator,
an uplink modulator and receiving modulators are enabled, respective frequencies (and bandwidth) of the free carrier are used and these parameters are notified to the uplink and/or transmitting equipment and receiving equipment for instance by SNMP.

A short waiting period is implemented until the radio link is available, the start of transmission is initiated, the transmission is terminated at a time defined by the operator, the sending modulator and the receiving modulator are disabled, these parameters are notified to the sending and receiving equipment e.g. by SNMP, for instance a mail or other information containing the booking confirmation is forwarded to the customer who has booked the transmission.

As described before, the solution according to the exemplary embodiment and/or exemplary method of the present invention and the control method offer the following services for managing the transmission capacity of a relay station of a transmission system in addition or as an alternative to the existing system of the non-IP (DVB) transmission of non-IP (e.g. MPEG) encoded contributions (e.g. by the available system):

It can be used solely or in combination with the available system. Depending on the format and/or encoding standard by which film contributions, interviews etc. are supplied as traffic to be transmitted, a transmission is feasible directly via DVB (by the available system) as described above or via the transmission links or TDMA, resp., based on the Internet protocol IP.

A transmission via the partial system based on the Internet protocol offers the following advantages to the user. The IP-based partial system is based on the Internet protocol. That means, in contrast to the “pure” MPEG via DVB, a contribution at the transmitter side can be automatically guided to the transmitting station via a local computer network and accordingly it can be automatically routed at the receiver side via a local computer network. To this end, standard protocols and standard methods are used. Such local computer networks can be e.g. an Intranet (in-house) or else the Internet. The system is thus compatible with the technology to be expected in the future, because the Internet protocol becomes more and more popular also in the field of media.

Furthermore not only a real-time or live mode is supported (in which a contribution is immediately and directly transmitted) but also a mode permitting store and forward transmitting can be supported. In the latter the producer of a contribution stores the same as a file on a server or data memory and specifies a time window within which the contribution is to be transmitted.

In contrast to the live transmission, therefore the transmission need not take place from a particular point in time, but the system searches a period of time within which it has free transmission capacity and then transmits the contribution via the relay station/the satellite to the receiving station(s). At the receiving station (s) the contribution is then again stored on a server/data memory where it is available for further use by the TV organization/the studio.

The system according to the exemplary embodiment and/or exemplary method of the present invention discriminates by way of the volume of a contribution (duration and bandwidth) whether the contribution is to be transmitted via a broad DVB link. In this case the contribution is converted via an IP/DVB gateway from the IP format into the DVB format and is transmitted at a transmission bandwidth of e.g. 16 Mbit/s (or 24 Mbit/s) within short time.

If, on the other hand, a shorter contribution is concerned and it is encoded, for instance, with a lower bandwidth, according to the exemplary embodiment and/or exemplary method of the present invention an alternative transmission path is used, namely via a TDMA transmission link. This transmission link or this transmission mode, respectively, also makes use of the satellite as relay station. The TDMA transmission supplements the DVB transmission by immediately providing transmission capacities for lower to medium data rates and offering an especially efficient allocation of the satellite bandwidth. It can be exploited by users also as an in-house telephone and data network covering several locations (keyword “voice over IP”, VoIP).

Within the network provided according to the exemplary embodiment and/or exemplary method of the present invention in addition or as an alternative to the available system, usually there is more than one transmitting station and the exchange of contributions between the different locations of transmitting stations is supported. For this purpose, a specific coordinating function is provided which regulates the concurring access of the different transmitting stations to the relay station (the satellite) such that no simultaneous transmissions are made on the same slot and, on the other hand, all requests for store and forward transmissions of the different locations are met as quickly and efficiently as possible.

To sum up, according to the exemplary embodiment and/or exemplary method of the present invention a combination of the transmission techniques IP/DVP and TDMA, both via satellite, is provided, wherein a plurality of transmitting stations and receiving stations or transmitting/receiving stations, respectively, each including a combination of both techniques are provided. An automatic control. unit coordinates and controls the access of the competing IP/DVB transmitting stations to the satellite capacity and the receiving equipment and moreover coordinates an automatic bandwidth allocation on the TDMA transmission system. Transmitting stations include servers on which contributions (e.g. interviews, reporting, films) are provided for transmission. The “owner” of the contributions releases them for transmission within a time window fixed by him and the system decides when such a contribution is transmitted and by which of the techniques available in the network it is transmitted (IP/DVB or TDMA). For the purpose of IP/DVB transmission the transmitting stations may include IP/DVB gateways which convert the IP data flow into DVB format for satellite transmission.

The control unit manages (e.g. in a data base) a directory of the contributions waiting for transmission (of the traffic to be transmitted) of the different locations, together with the requested time windows of the owners of the respective contributions. By way of this information and the respective occupation/availability of the resources required for a transmission (slot on the satellite, transmission arrangement also at the receiving side) the individual contributions are brought into a “fitting” order. It initiates the transmission appropriately and transmits the contributions on the servers of the transmitting stations in a store and forward mode via the respective partial system (IP/DVB or TDMA) via satellite and provides the contributions on the servers of the receiving stations.

Hence it results from the foregoing detailed description of the exemplary embodiment and/or exemplary method of the present invention that the control unit ensures that at any time only one transmitting station transmits on one slot (frequency and bandwidth), that the traffic is not interrupted unless it is appropriate, that both transmitting and receiving stations are taken into account, before it is switched to a different frequency or a different transmitting station is activated. Furthermore the control unit can be implemented such that a manual intervention, interruption, prioritization may be done, if it is required by the user or network manager, respectively.

In combination with that, the control unit works at least with the following priorities:

Priority 1: manual interventions can interrupt everything;
Priority 2: live transmissions and real-time traffic:
This cannot be interrupted by traffic of equal or lower priority; can extend beyond the agreed end time without requiring a confirmation; traffic which might be in conflict with that is newly coordinated;
Priority 3: store and forward transmissions: They occupy the available bandwidth; are transmitted as soon as possible; are automatically coordinated or re-coordinated; are transmitted within the user- or customer-specified and indicated time frame; are successfully terminated in the case of interruptions.

Furthermore, the network manager or an agent (cf. FIG. 4) can load or store new (encoded) contents and/or contributions, which represent traffic in the case of transmission, for later transmission and check available contents, define that particular ones of these contents are to be forwarded within a time window at a defined bit rate to a specific group of receivers, with or without encryption, with or without confirmation of a successful transmission, and determine who has to pay for the transmission. Moreover he can determine that a real-time traffic is to be transmitted, within a time window, at a defined bit rate, to a group of receivers, with or without encryption.

To sum up, the exemplary embodiment and/or exemplary method of the present invention relates to a control method for managing the transmission capacity of at least one relay station of a transmission system, a respective control unit, an appropriately adapted transmitting station, receiving station and relay station, wherein the control method comprises the steps of: coordinating (S53; FIG. 7) the transmission of the traffic to be transmitted with consideration of traffic coordinated already before within a specified time window and frequency range allowed for the transmission of the traffic to be transmitted, the traffic to be coordinated being composed of traffic contributions whose traffic volume is defined by the duration of the traffic contribution and the required bandwidth of the traffic contribution, and coordinating being carried out such that within the area of a frequency-time diagram defined by the allowed specified time window and the allowed frequency range the area of the traffic contributions is maximized.

1-17. (canceled)

18. A control method for managing a transmission capacity of at least one relay station of a transmission system, the control method comprising:
detecting traffic to be transmitted by at least two transmitting stations; and
coordinating transmission of the traffic to be transmitted with consideration of traffic already coordinated before within a specified time window and a frequency range allowed for the transmission of the traffic to be transmitted;
wherein the traffic to be coordinated is composed at least of traffic contributions to be transmitted in a store and forward mode whose traffic volume is defined by a duration of the traffic contribution and a required bandwidth of the traffic contribution, and
wherein the coordinating is performed so that within an area of a frequency-time diagram defined by the allowed specified time window and the allowed frequency range the area of the traffic contributions is maximized by shifting contributions to be transmitted in the store and forward mode within the frequency-time diagram and by coordinating the transmitting stations with each other;
wherein the transmission system includes the at least two transmitting stations, at least one receiving station, and a control unit for coordinating the at least one transmitting station, the at least one relay station and the at least one receiving station, wherein a respective one of the transmitting stations provides for transmission of at least one type of traffic to be transmitted in the store and forward mode, a respective receiving station receives the at least one type of traffic to be transmitted in the store and forward mode, and a respective relay station routes the at least one type of traffic to be transmitted in the store and forward mode from the transmitting station to the receiving station, and wherein the control unit coordinating the same performs the control method.

19. The method of claim 18, further comprising:
discriminating the types of traffic in the traffic to be transmitted;
determining the type of transmission for the respective traffic in response to the discriminated type of traffic; and
transmitting the traffic in the determined type of transmission from the respective at least one transmitting station via the at least one relay station to the respective at least one receiving station.

20. The method of claim 19, wherein the discriminating is performed by an identification denoting the type of traffic of the respective traffic.

21. The method of claim 19, wherein the discriminating is performed by an input interface denoting the type of traffic of the respective traffic at which the traffic is input.

22. The method of claim 18, wherein the coordinating of the traffic contributions is based on the priority of the traffic contributions.

23. The method of claim 22, wherein traffic contributions manually input by an operator are prioritized over real-time contributions which have priority over store and forward contributions.

24. The method of claim 23, wherein within the store and forward contributions, the prioritization is performed according to size so that within the store and forward contributions the largest traffic contributions to be transmitted are coordinated first.

25. The method of claim 23, wherein the traffic contributions manually input by an operator and the real-time contributions occupy a fixed partial area within an area of a frequency-time diagram.

26. A control unit for managing a transmission capacity of at least one relay station of a transmission system, the control unit comprising:
a detecting arrangement to detect traffic to be transmitted;
a coordinating arrangement to coordinate the transmission of the traffic to be transmitted with consideration of traffic already coordinated before within a specified time window and frequency range allowed for the transmission of the traffic to be transmitted, wherein the traffic to be coordinated includes at least of traffic contributions to be transmitted in a store and forward mode whose traffic volume is defined by a duration of the traffic contribution and a required bandwidth of the traffic contribution, and wherein the coordinating is performed so that within an area of a frequency-time diagram defined by the allowed specified time window and the allowed frequency range the area of the traffic contributions is maximized by shifting contributions to be transmitted in the store and forward mode within the frequency-time diagram; and
a control arrangement to control, in response to an output of the coordinating arrangement, a coordinated transmission of the traffic from a respective one of at least two transmitting stations via the at least one relay station to a respective one of at least one receiving station and to coordinate the transmitting stations with each other;
wherein the transmission system includes the at least two transmitting stations, and the at least one receiving station, wherein the respective transmitting station provides for transmission of at least one type of traffic to be transmitted in the store and forward mode, the respective receiving station receives the at least one type of traffic to be transmitted in the store and forward mode, and the respective relay station routes the at least one type of traffic to be transmitted in the store and forward mode from the transmitting station to the receiving station.

27. The control unit of claim 26, further comprising:
a discriminating arrangement to discriminate the types of traffic in the traffic to be transmitted; and
a determining arrangement to determine the type of transmission for the respective traffic in response to the discriminated type of traffic.

28. The control unit of claim 27, wherein the discriminating arrangement discriminates by an identification denoting the type of traffic of the respective traffic.

29. The control unit of claim 27, wherein the discriminating arrangement discriminates by an input interface denoting the type of traffic of the respective traffic at which the traffic is input.

30. The control unit of claim 26, wherein the coordinating arrangement coordinates the traffic contributions by the priority of the traffic contributions.

31. The control unit of claim 30, wherein traffic contributions manually input by an operator are prioritized over real-time contributions which have priority over store and forward contributions.

32. The control unit of claim 31, wherein within the store and forward contributions, the prioritization is performed according to size so that within the store and forward contributions the largest traffic contributions to be transmitted are coordinated first.

33. The control unit of claim 31, wherein the traffic contributions manually input by an operator and the real-time contributions occupy a fixed partial area within the area of a frequency-time diagram.

34. A transmission system comprising:
at least two transmitting stations;
at least one relay station;
at least one receiving station, wherein a respective one of the transmitting stations provides for transmission of at least one type of traffic to be transmitted in the store and forward mode, a respective receiving station receives the at least one type of traffic to be transmitted in the store and forward mode, and a respective relay station routes the at least one type of traffic to be transmitted in the store and forward mode from the transmitting station to the receiving station; and
a control unit for managing a transmission capacity of the at least one relay station of the transmission system, the control unit including:
a detecting arrangement to detect traffic to be transmitted;
a coordinating arrangement to coordinate the transmission of the traffic to be transmitted with consideration of traffic already coordinated before within a specified time window and frequency range allowed for the transmission of the traffic to be transmitted, wherein the traffic to be coordinated includes at least of traffic contributions to be transmitted in a store and forward mode whose traffic volume is defined by a duration of the traffic contribution and a required bandwidth of the traffic contribution, and wherein the coordinating is performed so that within an area of a frequency-time diagram defined by the allowed specified time window and the allowed frequency range the area of the traffic contributions is maximized by shifting contributions to be transmitted in the store and forward mode within the frequency-time diagram; and
a control arrangement to control, in response to an output of the coordinating arrangement, a coordinated transmission of the traffic from the respective one of at least two transmitting stations via the at least one relay station to the respective one of at least one receiving station and to coordinate the transmitting stations with each other.
